(19) United States
(12) Patent Application Publication
(10) Pub. No.: US 2019/0042950 A1
(43) Pub. Date: Feb. 7, 2019

(54) LEARNING COMPUTING ACTIVITIES AND RELATIONSHIPS USING GRAPHS

(71) Applicant: CA, Inc., New York, NY (US)

(72) Inventors: Cui Lin, Sunnyvale, CA (US); Simon Cockayne, Charlottesville, VA (US); Robert Anthony Layzell, Novato, CA (US)

(21) Appl. No.: 15/710,214

(22) Filed: Sep. 20, 2017

Related U.S. Application Data
(60) Provisional application No. 62/540,026, filed on Aug. 1, 2017.

(51) Int. Cl. G06N 5/02; G06F 17/30; G06F 11/34; G06N 99/00

(52) U.S. Cl. CPC G06N 5/022; G06N 99/005; G06F 11/3438; G06F 17/30958

(57) ABSTRACT

Techniques are disclosed relating to building a graph data structure based on information associated with a plurality of services available over a network. The information may include datasets associated with a plurality of software services available to the set of users. The datasets may be analyzed, wherein the analyzing comprises determining, using one or more machine learning algorithms, a plurality of objects, including objects representing ones of the set of users and a plurality of computing activities. A graph data structure may be formed, comprising the plurality of objects, that indicates relationships between the plurality of objects. The graph data structure may be updated in response to detecting additional computing activities of one or more of the set of users. A plot of a subset of the plurality of objects in the graph data structure may be generated in response to a request. The plot may be caused to be displayed on a display.

This application claims the benefit of U.S. Provisional Application No. 62/540,026, filed on Aug. 1, 2017, which is incorporated by reference herein in its entirety.

### BACKGROUND

### Technical Field

This disclosure relates generally to machine learning and more particularly to building a multi-dimension and evolved learning network as an integrated knowledge base of an entity.

### Description of the Related Art

An entity may have access to and/or generate unstructured and structured data as a result of its activities. By way on non-limiting example, an entity may use electronic mail services, conduct transactions, and develop products and/or services. Each of these services generates data as output. This data may contain useful information that can be used to make informed decisions based on these separate data sources. Techniques exist for analyzing data that may be used to support decision-making based on information discerned from the data.

### BRIEF SUMMARY

Information indicative of computing activities of a set of users and/or relationships between the set of users and computing resources within a computing domain may be accessed. The information may include datasets associated with a plurality of software services available to the set of users. The datasets may be analyzed, wherein the analyzing comprises determining, using one or more machine learning algorithms, a plurality of objects, including objects representing ones of the set of users and a plurality of computing activities and/or computing resources. A graph data structure may be formed, comprising the plurality of objects, that indicates relationships between the plurality of objects. The graph data structure may be updated in response to detecting additional computing activities of one or more of the set of users and/or additional computing resources. A plot of a subset of the plurality of objects in the graph data structure may be generated in response to a request. The plot may be caused to be displayed on a display.

### BRIEF DESCRIPTION OF THE DRAWINGS

FIG. 1 is a block diagram depicting various embodiments of a system 100.

FIG. 2 is a block diagram depicting various embodiments of a processing module 200 such as the processing module depicted in system 100.

FIG. 3 is a block diagram depicting various embodiments of a flow diagram illustrating use of system 100.

FIG. 4 is a diagram illustrating embodiments of a representation of a graph data structure formed using a system such as system 100.

FIG. 5 is a diagram illustrating an example of a graphical representation of a graph data structure, according to some embodiments.

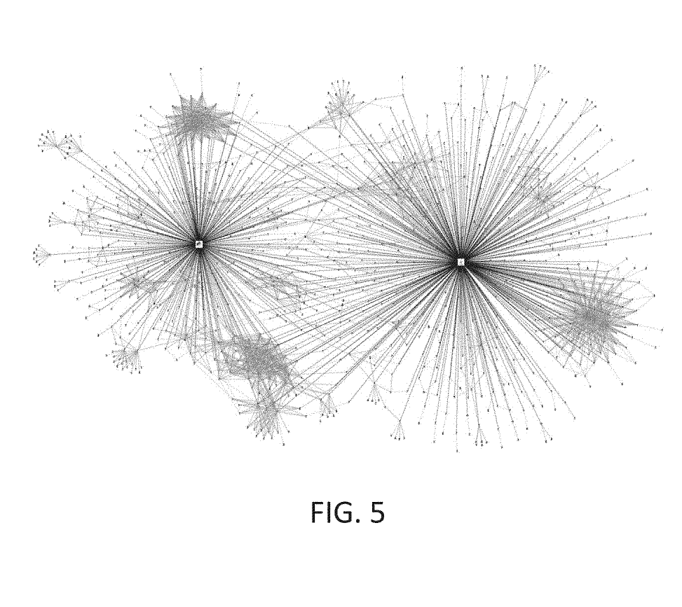

FIG. 6 is a diagram illustrating an example of building a model, according to some embodiments.

FIG. 7 is a flow diagram illustrating embodiments of a method 700 for building a graph data structure.

FIG. 8 is a flow diagram illustrating embodiments of a method 800 for building a graph data structure.

FIG. 9 is a flow diagram illustrating embodiments of a method 900 for training a model using a graph data structure.

FIG. 10 is a block diagram illustrating an exemplary computing device, according to some embodiments.

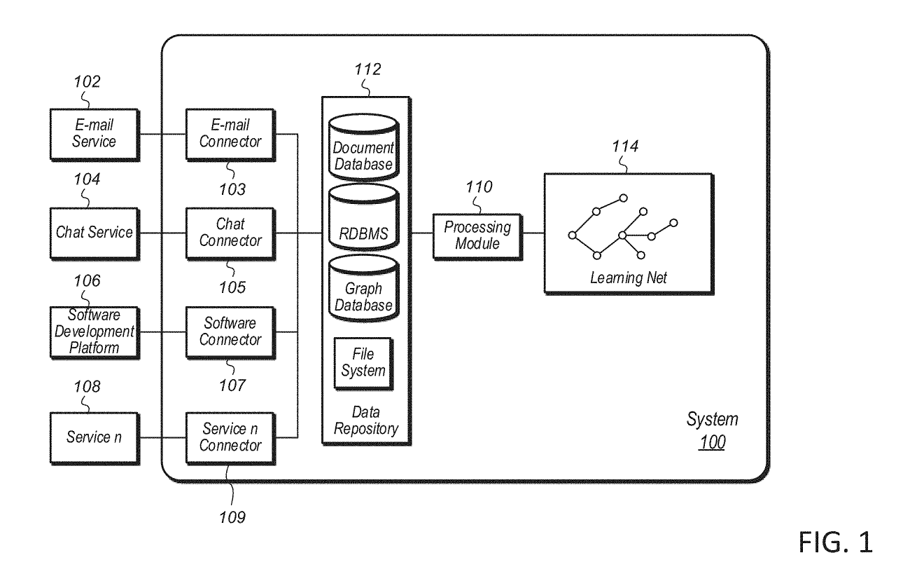

References may be made in this application to “one embodiment” or “embodiments” of a particular concept, such as those illustrated with respect to the figures listed above. The term “embodiment” refers to an instance of a particular concept, such as apparatus or method. Consider FIG. 1, which depicts a particular configuration of a system 100. FIG. 1 may thus be said to represent “one embodiment” of a system. But system 100 can also be said to represent multiple embodiments of a system, as in practice, many different systems may be implemented that share the common characteristics illustrated in FIG. 1. Use of the terms “embodiment” and “embodiments” are thus used to emphasize that the present application is intended to cover many different implementations.

Various aspects of embodiments described in this application are described using definitions, examples, and other context provided in the Detailed Description. As such, both the originally filed claims and claims that are subsequently drafted during prosecution of this application or an application that claims priority to this application are intended to be interpreted according to this guidance.

### DETAILED DESCRIPTION

Techniques are disclosed relating to building a graph data structure. An entity (e.g., an enterprise, an organization, an individual, etc.) may have access to and/or generate data as a result of the entity's computing activities and/or computing resources. This data may contain useful information that can be used to make informed decisions. However, the data may persist in heterogeneous systems and/or may exist within a pool of unstructured data such that analysis of the data as a whole may be difficult or impossible using traditional techniques. Furthermore, the quantity of the data may make analysis expensive, both in terms of computational requirements and in terms of time. This issue is compounded by the fact that additional information is being generated on a continual basis.

Traditional techniques may be poorly suited to analyze data generated by an entity's computing activities. For example, use of traditional relational models and relational database management systems (RDBMSs) may entail various disadvantages when applied to the analysis of large, unstructured datasets. Some query patterns, such as deep and recursive joins or pathfinding operations, may require large amounts of hardware and software resources. Even if resources are dedicated to such queries, traditional relational models may result in slow computation speeds, which may be intolerable to users in some use cases. One reason for these drawbacks is that relational data models target structured data; performing join operations using a relational data model is computationally expensive because these data models use matching of primary or foreign keys to construct large result sets from multiple logically separated tables. If an entity wants to analyze large, unstructured datasets, traditional relational models may not offer a desirable platform to do so. This may be because for unstructured data, the format of the data is not pre-defined from the perspective of the software module that is doing the analysis. In contrast, structure data has a pre-defined or known structure.

FIG. 1 is a block diagram depicting various embodiments of a system 100. System 100 may be used to build learning nets, as further discussed below. Users associated with an entity may generate data by engaging with one or more software services in a computing domain. The phrase “computing domain” means a network (or a collection of networks) of computing devices and/or computing resources of interest. The computing domain of an entity includes a local network of computing devices and computing resources, such as those computing devices and computing resources available over a Local Area Network (LAN), and also over remotely-accessible networks, such as the Internet.

There are many types of software services available to users within a computing domain of interest, such as those computing resources of a particular entity. Such services may be accessible over a network of the entity. For example, users associated with an entity may have access to a plurality of services over the entity's network (e.g., within the entity's computing domain). Examples of software services include an electronic mail (i.e., e-mail) service (e.g., Microsoft Outlook, G-Mail, Yahoo Mail, AOL Mail, etc.) a chat service (e.g., Yammer, Google Hangouts, Slack, etc.), a software development platform (e.g., GitHub, Jira, etc.), a document development platform (e.g., Microsoft Word, Google Docs, etc.), a management service (e.g., Waffle, Agile Central, VersionOne, etc.), a social media service (e.g., Twitter, LinkedIn, Facebook, etc.), a webpage hosting service (e.g., a blog), and a mainframe service (e.g., an organizational chart, etc.) among others. Analysis of any suitable type of software service is contemplated by the present disclosure. FIG. 1 depicts e-mail service 102, chat service 104, software development service 106, and service 108. Service 108 includes any software service that is accessible over a network of an entity. Note that the software services 102, 104, 106, and 108 that are illustrated in FIG. 1 are shown for illustrative purposes only, and that a lesser or a greater number of software services may be accessible over the network of an entity.

As users perform computing activities within a computing domain, such as by engaging with software services or otherwise, information indicative of these computing activities is generated. The phrase “computing activities” includes any engagement of a software service by a user, including activities that may be performed locally. For example, the phrase “computing activities” includes the use of an e-mail service to send and/or receive an e-mail, the use of a chat service to send and/or receive a message, the use of a software development platform to develop, share, save, modify, access, and/or otherwise engage with software that is developed via the software development platform, and the use of a webpage hosting service to develop, share, save, modify, access, and/or otherwise engage with a webpage that is hosted via the webpage hosting service.

The information that is generated via engagement of the software services and any other computing activities of a set of users may include datasets associated with the software services available to the users. Each software service may generate and/or store a dataset that indicates the computing activities of each user with respect to that software service. For example, an e-mail service may generate and/or store a dataset that indicates the use of the e-mail service by each user of a plurality of users. The dataset associated with the e-mail service may include data (such as a name or other identification of the sender, a name or other identification of the recipient(s), the content of the e-mail, etc.) and/or metadata (such as a time stamp associated with various actions that can be taken, such as the drafting, sending, and/or receiving of the e-mail). The data in one or more of the datasets may be unstructured. For example, a portion of a dataset or an entire dataset may be unstructured. An unstructured dataset is a dataset that does not have a pre-defined structure from the perspective of a software module that analyzes the dataset. These datasets may be stored separately (e.g., in separate data repositories) such that each software service stores a dataset in a separately accessible data repository.

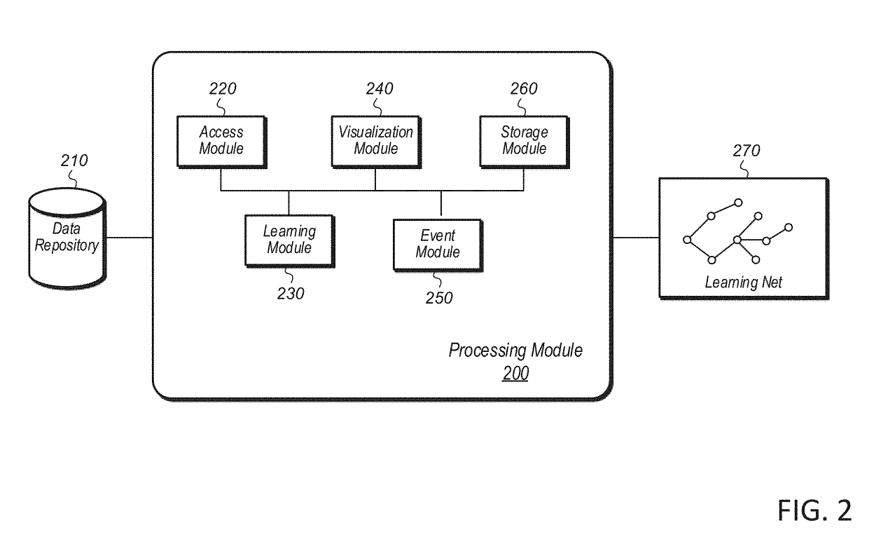

The information indicative of the computing activities may be stored locally (e.g., in one or more data repositories, such as a database, within the computing domain of the entity) and/or remotely (e.g., in one or more data repositories, such as a database, accessible over a network, such as the Internet). System 100 may access the information indicative of the computing activities via respective connectors for each service. FIG. 1 illustrates e-mail connector 103 that accesses information generated via e-mail service 102. Chat connector 105 access information generated via chat service 104. Software connector 107 accesses information generated via software development platform 106. Service connector 109, which represents a non-specific service connector, accesses information generated via software service 108, which represents a non-specific software service. System 100 may access the data stored by the connectors via processing module 110, which is discussed in greater detail with respect to FIG. 2.

System 100 as illustrated in FIG. 1 includes data repository 112. Data repository 112 may store data associated with the entity (e.g., data generated by the computing activities of the entity). Data repository 112 may include a single database or, as illustrated in FIG. 1, a plurality of databases. Data repository 112 may be a data lake, a data warehouse, or any other type of data repository. In the embodiment illustrated in FIG. 1, data repository 112 includes a document database, a relational database management system (RDBMS), a graph database, and a file system. One or more datasets generated via use of the software services available over the entity's network may be stored in data repository 112. Note that data repository 112 may store data other than the datasets generated via use of the software services. For example, data repository 112 may store user files (e.g., data stored by one or more users). Examples of user files may include employee records, personnel files, reference materials, or any other data that is stored by a user.

System 100 may be used to build learning net 114 based on information indicative of computing activities of a set of users within a computing domain. The information may include datasets associated with a plurality of software services available to the set of users. The datasets may be analyzed, wherein the analyzing comprises determining, using one or more machine learning algorithms, a plurality of objects, including objects representing ones of the set of users and a plurality of computing activities. The learning net may be formed as a graph data structure comprising the plurality of objects, wherein the learning net indicates relationships between the plurality of objects. The graph data structure may be updated in response to detecting additional computing activities of one or more of the set of users. A plot of a subset of the plurality of objects in the graph data structure may be generated in response to a request. The plot may be caused to be displayed on a display.

FIG. 2 is a block diagram depicting various embodiments of a processing module 200 such as the processing module depicted in system 100. Processing module 200 may be configured to perform one or more functions, wherein the functions may be performed automatically and/or in response to user input (e.g., user input received via user interface 116). Processing module 200 includes access module 220. As noted above, processing module 200 may be configured to access information indicative of computing activities of a set of users within a computing domain. This information may include datasets associated with a plurality of software services available to the set of users. The information indicative of computing activities may be stored in one or more data repositories, such as data repository 210. Note that although a single data repository is illustrated in FIG. 2, processing module 200 may be configured to access information in a plurality of data repositories (e.g., in one or more data repositories associated with software services 102, 104, 106, or 108, in data repository 112). In other words, processing module may be configured to access a single data repository and/or multiple data repositories.

The term “module” refers to circuitry configured to perform specified operations or to physical non-transitory computer readable media that stores information (e.g., program instructions) that instructs other circuitry (e.g., a processor) to perform specified operations. Such circuitry may implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Processing module 200 includes learning module 230. Processing module 200 may be configured to analyze the datasets that are associated with a plurality of software services via learning module 230. Learning module 230 may be configured to determine a plurality of objects, including objects representing ones of the set of users and a plurality of computing activities. The term “object” refers to a data structure that represents an item within a dataset. For example, objects may represent people (including individual people and/or groups of people), projects, or subjects. An object may represent a particular individual, such as an employee, a contact, or any other person that is associated with an entity. An object may represent a project, such as a particular project that was previously developed, is currently being developed, and/or will be developed by and/or for an entity. An object may represent a subject, which refers to a particular skill and/or area that an individual or group may have experience with. For example, a plurality of objects may respectively represent various skillsets that include project management, engineering, programming, computer science, artificial intelligence, and the like. Note that the above list of subjects is not exhaustive and that other subjects are intended to fall within the scope of the present disclosure.

Learning module 230 may determine the plurality of objects using one or more machine learning algorithms. For example, analysis module may determine the plurality of objects using natural language processing. The phrase “natural language processing” is intended to include its ordinary meaning and includes the use of one or more algorithms that analyze words to discern meaning from the words. For example, natural language processing may be used to determine objects of a graph data structure based on the structure of a sentence in a data repository (e.g., a sentence in an e-mail repository). The contacts of a person and/or projects that the person is working on or has worked on, for example, may be determined based on e-mails associated with that person. These objects may be added to a graph data structure, which indicates the relationships between the person, the contact, and the projects.

Learning module 230 may form a learning net (e.g., a graph data structure) that includes the plurality of objects determined from the datasets. The phrase “graph data structure” refers to a data structure that includes nodes and an indication of relationships between the nodes. The nodes of the graph data structure may include the plurality of objects determined from the datasets and may indicate the relationships between the nodes. Note that the plurality of objects may be determined from the datasets and from additional information, such as information stored in data repository 112. In other words, the plurality of objects may be determined by learning module 230, wherein the plurality of objects includes objects representing information generated by use of a plurality of software services available to a plurality of users within a computing domain and also object representing information stored by one or more users. According to some embodiments, the graph data structure may be a graph database.

The graph data structure may include information indicative of the computing activities of a plurality of users of an entity. As a plurality of software services are used, additional information is generated as a result of their use. In other words, in many cases software services are used, datasets that result from use of the software services are generated on a continual basis. Learning module 230 may be configured to analyze these datasets in response to user input and/or automatically (e.g., periodically and/or in response to detecting an update to one or more datasets). For example, responsive to detecting additional computing activities of one or more users, system 100 may store additional data generated by the additional computing activities in respective datasets. Learning module 230 may be configured to determine one or more additional objects, including objects representing ones of the one or more users and the additional computing activities. In other words, learning module 230 may be configured to update the learning net (e.g., update the graph data structure), for example in response to detecting additional computing activities of one or more users.

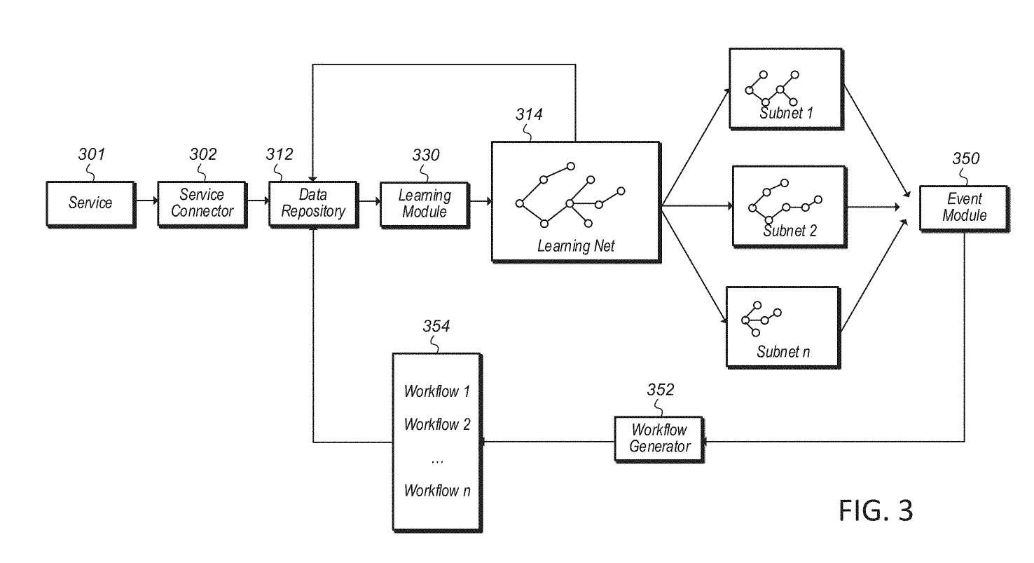

FIG. 3 is a block diagram depicting various embodiments of a flow diagram illustrating use of system 100. Service 301 is a software service that is available to users within a computing domain of an entity. Service 301 may correspond to one or more of e-mail service 102, chat service 104, software development service 106, and/or service 108. Note that a single service 301 is illustrated in FIG. 3, but any number of services may be used within the scope of the embodiments illustrated in FIG. 3. Connector 302 may be used to access information generated via use of service 301.

Data repository 312 may store data that is generated by the computing activities of the entity (or members of the entity) according to the techniques described above. Similar to data repository 112 of FIG. 1, data repository 312 may include a single database or a plurality of databases. For example, data repository 312 may include a document database, a RDBMS, a graph database, and/or a file system. One or more datasets (e.g., datasets generated via use of software service 301) may be stored in data repository 312. Data repository 312 may store data other than datasets generated via use of software service 301, including, for example, data stored by one or more users, such as employee records, personnel files, reference materials, or any other data that is stored by a user.

Learning module 330 may be configured to analyze data in data repository 312. Learning module may be configured to determine a plurality of objects, including objects representing ones of the set of users and a plurality of computing activities. Learning module 330 may build (or form) learning net 314, which includes the objects that represent the ones of the set of users and the plurality of computing activities. As discussed above, a learning net such as learning net 314 may include nodes and relationships between the nodes. Learning net 314 may be a graphical data structure.

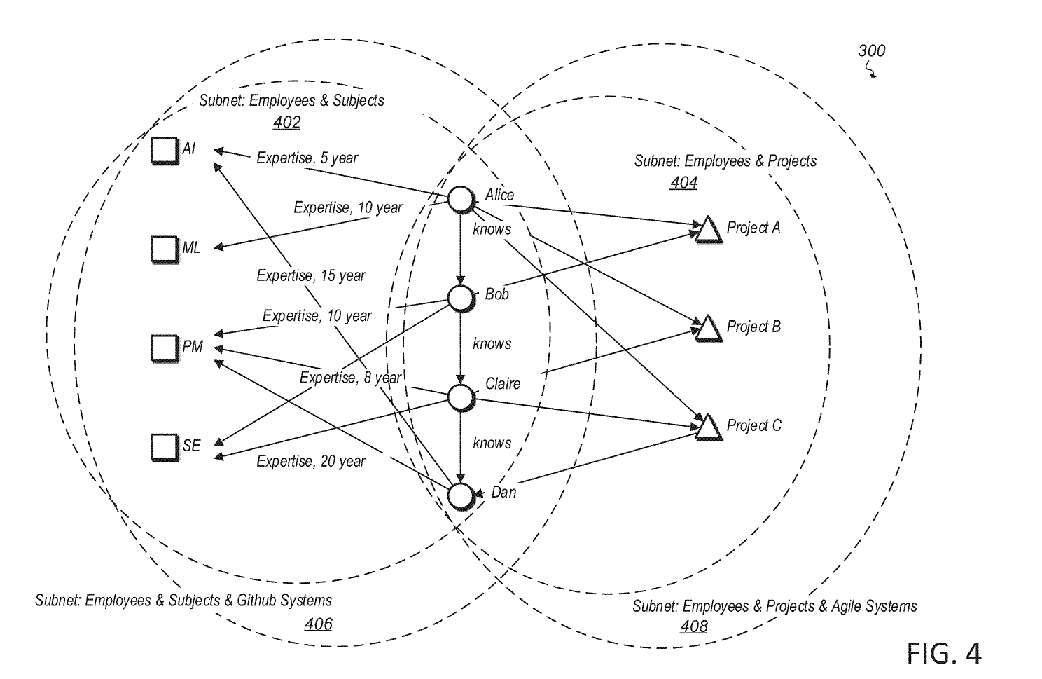

One or more subnets may be formed based on learning net 314. For example, FIG. 3 includes Subnet 1, Subnet 2, and Subnet n. Note that any number of subnets may be formed based on learning net 314. A subnet includes a subset of the objects that comprise learning net 314. A subnet may be formed in response to a user query that indicates an object within learning net 314. Subnets are discussed in greater detail below with respect to FIG. 4.

FIG. 4 is a diagram illustrating embodiments of a representation of a graph data structure formed using a system such as system 100. FIG. 4 illustrates various objects that are represented as nodes in the learning net, including subjects (depicted in FIG. 4 as square boxes) such as “AI,” or artificial intelligence, “ML,” or machine learning, “PM,” or project management, and “SE,” or software engineering. FIG. 4 also includes people (depicted as circles), such as Alice, Bob, Claire, and Dan. FIG. 4 also includes projects (depicted as triangles), such as Projects A, B, and C. The objects in FIG. 4 are representative in items in datasets that were analyzed to determine the objects. The net illustrated in FIG. 4 also includes the relationships between the objects, which are illustrated by lines between the nodes. For example, the relationship between Alice and AI indicates that Alice has 5 years of expertise in artificial intelligence. The relationship between Alice and Bob indicates that Alice knows Bob. The relationship between Alice and Project A indicates that Alice is associated with Project A. Subnets 402, 404, 406, and 408 are illustrated in FIG. 4 by the dashed ovals that surround a subset of the objects in FIG. 4. For example, subnet 402 is a subset of the objects in the graph data structure comprising objects that represent employees and subjects. Subnet 404 is a subset of the objects in the graph data structure comprising objects that represent employees and projects. The representation illustrated in FIG. 4 is one embodiment of a graph data structure that may be formed by learning module 230.

Referring back to FIG. 2, visualization module 240 may generate a plot of a subset of the plurality of objects in the graph data structure. The plot may be generated in response to receiving a request from a user (e.g., via user interface 116). Processing module 200 may receive the request via event module 250. Event module 250 may be configured to parse the request to determine an action to take in response to the receiving the request (which is described in greater detail below).

The plot generated by visualization module 240 may include a graphical representation of the subset of the plurality of objects as nodes and relationships between the subset of the plurality of objects as lines between the nodes. The plot may be formed in response to receiving an indication in the request of at least one particular object of the plurality of objects. Generating the plot may include identifying the subset of the plurality of objects based on the at least one particular object. In other words, a user may indicate a particular object (or a plurality of particular objects), such as an employee, and visualization module 240 may identify a subset of the plurality of objects in the graph data structure based on the particular object. For example, visualization module 240 may identify one or more projects that the employee is associated with. Alternatively, visualization module 240 may identify a skill associated with the employee. The graph data structure may be accessed to determine a level of expertise that the employee has with respect to the skill (e.g., the expertise may be expressed in terms of time, such as 5 years experience, or with any other suitable descriptor) and/or a relationship the employee has with respect to the skill (e.g., the employee enjoys, to various degrees, performing work using the skill). FIG. 4 is a diagram illustrating an example of a graphical representation of a graph data structure, according to some embodiments. FIG. 4 indicates a plot of a plurality of nodes and lines between the nodes. The plurality of nodes in FIG. 4 are representative of a plurality of objects (e.g., objects that are determined by analysis of one or more datasets, such as datasets generated by use of a plurality of software services). Processing module 200 may cause the plot to be displayed on a display (e.g., a display that is communicatively coupled to system 100).

Event module 250 may be configured to detect an event. As noted above, a user may subscribe to receive an alert in response to a detection of a predetermined event. For example, a user may subscribe to receive an alert in response to a detected change in a dataset. The change in the dataset may indicate a change in a status of an object in the graph data structure. For example, an object in the graph data structure that represents a person may indicate a status of the employee (e.g., a personal status, such as “single”). Additionally, the graph data structure may indicate a relationship between a plurality of objects, such as a person and a subject. The relationship may indicate a level of expertise of the person with respect to the subject. Additionally, the graph data structure may indicate a status of a relationship, such as a status between a person and a project (e.g., a status of a relationship between a person and a project may indicate the person's progress with respect to the project, such as “current” or “behind schedule,” or the person's availability to work on the project, such as “available” or “busy with high priority work”). If analysis by event module 250 (e.g., in response to detecting additional computing activities) indicates that a status of an object or a relationship has changed (e.g., a status of an object has changed from “single” to “married,” or a relationship between a person and a skill has changed), that change may be detected by event module 250. One or more users may subscribe to changes in identified object and/or relationships between objects. In response to the detected change, an alert may be sent to the subscribed one or more users. According to some embodiments, a workflow may be initiated in response to the detected change. The term “workflow” refers to an event or chain of events that occurs (or is caused to occur) to accomplish a task. The workflow may be automated such that the workflow is initiated automatically in response to a triggering event. Referring to FIG. 3, event module 350 may detect an event, such as a change in an object or in a relationship between a plurality of objects. A detected change in an object or in a relationship between a plurality of objects may trigger an automated workflow (e.g., one or more of workflows 354 such as Workflow 1, Workflow 2, or Workflow n). The automated work flow may be initiated by workflow generator 352. For example, if the status of a person (e.g., an employee) changes from “single” to “married,” one or more workflows may be initiated that includes sending a benefits package to the person from human resources. As another example, if a relationship between a person and a subject indicates that the person's level of skill with respect to the subject has changes, a workflow may be initiated that includes initiating a review of the person's compensation level. Information generated as a result of the automated workflow may be added to data repository 312.

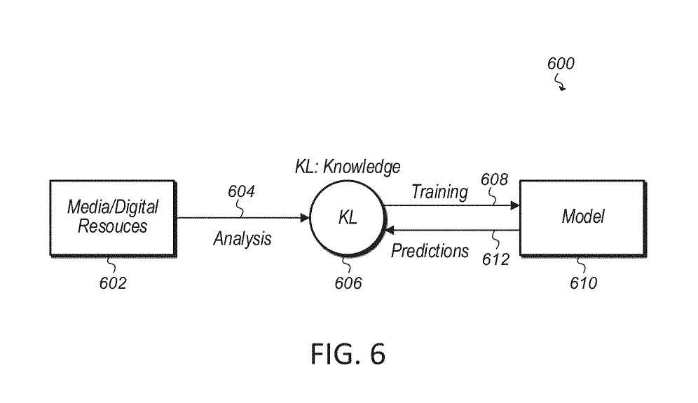

FIG. 6 is a diagram illustrating an example of building a model, according to some embodiments. FIG. 6 illustrates digital/media resources 602. Digital/media resources 602 include data repositories that store data generated by an entity, such as data generated by use of software services available to users over a network, and also data stored by one or more users. Digital/media resources 602 may include data in data repository 112. System 100 may be used to generate a learning net, shown in FIG. 6 as analysis 604, as described above. The learning net, which represents the knowledge 606 of an entity, may be represented as a graph data structure. Processing module 200 may be configured to train a model 510, shown in FIG. 6 as training 608, to make a predictive assessment 612 of an object in the graph data structure. Predictive assessments 612 may be added to the knowledge 606 of an entity by adding and/or updating the graph data structure. The process of training a model to make predictive assessments is described in greater detail below.

Referring back to FIG. 2, processing module 200 may receive or retrieve an indication of a particular criterion or criteria. For example, processing module may receive an indication of the particular criterion via learning module 230 in the form of user input. The particular criterion may include one or more objects in the graph data structure. For example, a user may indicate a particular criterion, such as a subject (e.g., Java programming). The model may be used to make a predictive assessment of an object in the graph data structure with respect to the particular criterion. Referring back to the Java programming example, the model may be used to make a predictive assessment of a person's skill with respect to Java programming.

Learning module 230 may identify a subset of objects in the graph data structure based on the particular criterion. For example, learning module 230 may identify one or more of the objects in the graph data structure that have a relationship with the object(s) identified as the particular criterion as indicated by the graph data structure. Returning to the programming language example, learning module 230 may identify people that have contributed to a data repository for a software development platform in the programming language.

Learning module 230 may train the model using data associated with the subset of objects, wherein the model generates predictive assessments of objects in the subset with respect to the particular criterion. The model may include a neural network that generates a predictive assessment of an object as an output. The term “neural network” is intended to be construed according to its well-understood meaning in the art, which includes data specifying a computational model that uses a number of nodes, wherein the nodes exchange information according to a set of parameters and functions. Each node is typically connected to many other nodes, and links between nodes may be enforcing or inhibitory in their effect on the activation of connected nodes. The nodes may be connected to each other in various ways; one example is a set of layers where each node in a layer sends information to all the nodes in the next layer (although in some layered models, a node may send information to only a subset of the nodes in the next layer).

A baseline dataset may supply data to train the model. The baseline dataset may include datasets that have been indicated by a user via user input. Learning module 230, in some embodiments, may be configured to train the model using the baseline dataset. The term “training” a model, as used herein, is intended to be construed according to its well-understood meaning in the art, which includes, but is not limited to processing data with the model (e.g., a neural network), determining a difference between output data and baseline dataset, and adjusting the parameters of the model based on the difference. In some embodiments, training a model may proceed without comparison against a baseline dataset. According to some embodiments, responsive to receiving an indication of a positive evaluation of the model (e.g., via independent verification of the output of a model by a user), the model may be trained using data in a second subset of the graph data structure that is larger than the baseline dataset.

After a model has been trained (e.g., by learning module 230), system 100 may receive a request to generate a predictive assessment of a first object using the model. Learning module 230 may generate a predictive assessment of the first object using the model. The predictive assessment of the first object may be compared to an independent assessment of the first object. If the predictive assessment differs from the independent assessment, an alert may be generated. For example, the predictive assessment may be flagged for review (such as by a user). Additionally and/or alternatively, and indication of the predictive assessment may be transmitted to a user. The predictive assessment of the first object may be stored (e.g., added to the graph data structure) by storage module 260. Storing the first object may include updating one or more datasets that stored in a data repository within the computing domain.

Turning now to an example implementation, one or more services available to users in a computing domain may include a software development platform. A data repository may store information that is indicative of computing activities of one or more users with respect to the software development platform. For example, the data repository may store data that was written and/or developed by one or more users in one or more programming languages. A graph data structure may be formed based on an analysis of the information indicative of the computing activities of the one or more users. As users engage with the one or more services, additional data indicative of additional computing activities may be added to the graph data structure. A model may be trained that makes predictive assessments of one or more users with respect to a skill set of the users. For example, the model may make a predictive assessment of a user's level of expertise with respect to a particular programming language. The model may be trained using a baseline dataset. Once the model has been trained, the model may be used to make a predictive assessment of a first object in the graph data structure. The predictive assessment may be compared to an independent assessment.

Note that an entity may be associated with many people (e.g., a company may have hundreds or thousands of employees or an organization may have hundreds or thousands of members) and may be interested in discerning information with respect to many different skills (e.g., the employees of a company may develop products and/or services using dozens or hundreds of programming languages). A level of expertise a person may have with respect to a skill may be discerned (or approximated) based on the computing activities of the person (e.g., number of code modules worked on, lines of code written and/or edited, months or years spent programming in a particular language). System 100 may be used to discern such information based on information generated by the computing activities of a set of users.

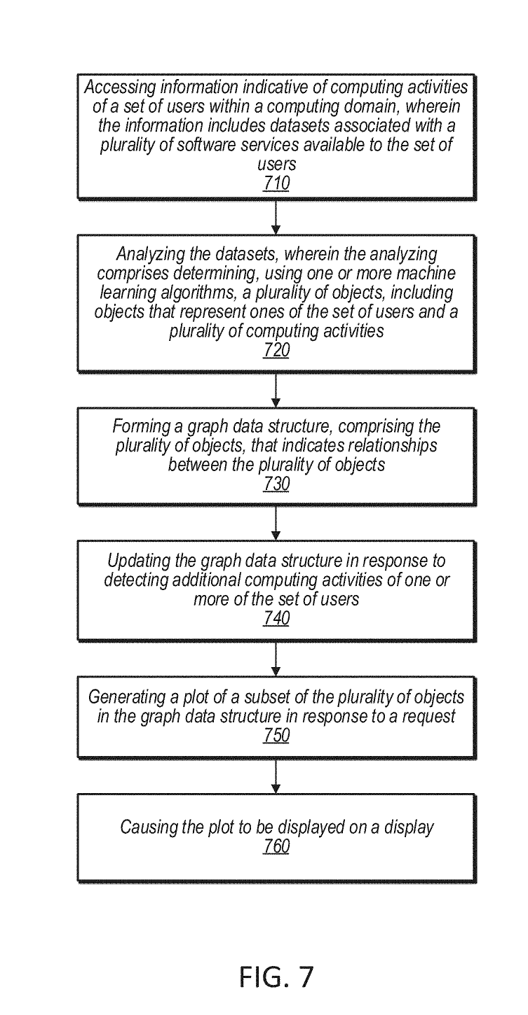

FIG. 7 is a flow diagram illustrating embodiments of a method 700 for building a graph data structure. At 702, information indicative of computing activities of a set of users within a computing domain is accessed, wherein the information includes datasets associated with a plurality of software services available to the set of users. At 704, the datasets are analyzed, wherein the analyzing comprises determining, using one or more machine learning algorithms, a plurality of objects, including objects representing ones of the set of users and a plurality of computing activities. At 706, a graph data structure, comprising the plurality of objects, that indicates relationships between the plurality of objects is formed. At 708, the graph data structure is updated in response to detecting additional computing activities of one or more of the set of users. At 710, a plot of a subset of the plurality of objects in the graph data structure is generated in response to a request. At 710, the plot is caused to be displayed on a display.

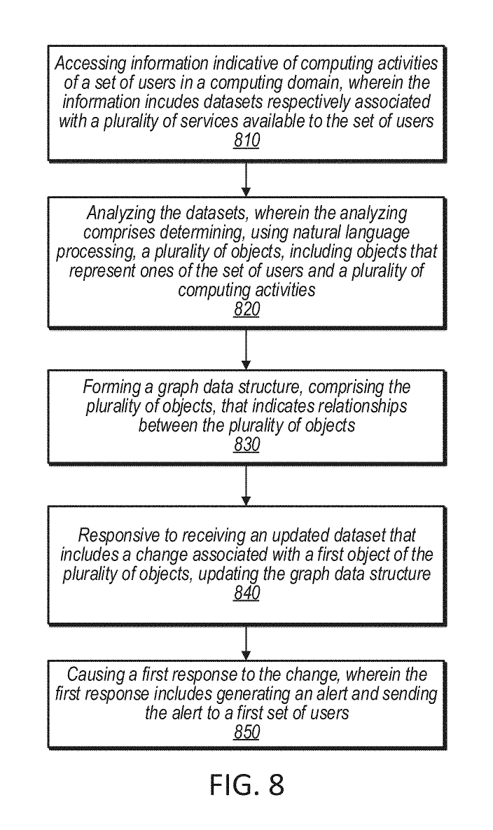

FIG. 8 is a flow diagram illustrating embodiments of a method 800 for building a graph data structure. At 810, information indicative of computing activities of a set of users within a computing domain is accessed, wherein the information includes datasets associated with a plurality of software services available to the set of users. At 820, the datasets are analyzed, wherein the analyzing comprises determining, using one or more machine learning algorithms, a plurality of objects, including objects representing ones of the set of users and a plurality of computing activities. At 830, a graph data structure, comprising the plurality of objects, that indicates relationships between the plurality of objects is formed. At 840, the graph data structure is updated responsive to receiving an updated dataset that includes a change associated with a first object of the plurality of objects. At 850, a first response to the change is caused, wherein the first response includes generating an alert and sending the alert to a first set of users.

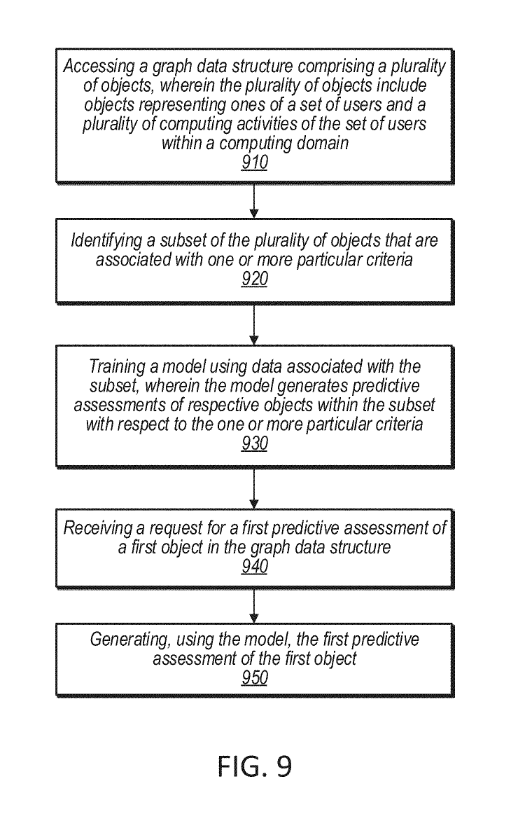

FIG. 9 is a flow diagram illustrating embodiments of a method 900 for training a model using a graph data structure. At 910, a graph data structure comprising a plurality of objects is accessed, wherein plurality of objects include objects that represent ones of a set of users and a plurality of computing activities of the set of users within a computing domain. At 920, a subset of the plurality of objects that are associated with one or more particular criteria are identified. At 930, a model is trained using data associated with the subset, wherein the model generates predictive assessments of respective objects within the subset with respect to the one or more particular criteria. At 940, a request for a first predictive assessment of a first object in the graph data structure is received. At 950, using the model, the first predictive assessment of the first object is generated.

### Example Computer System

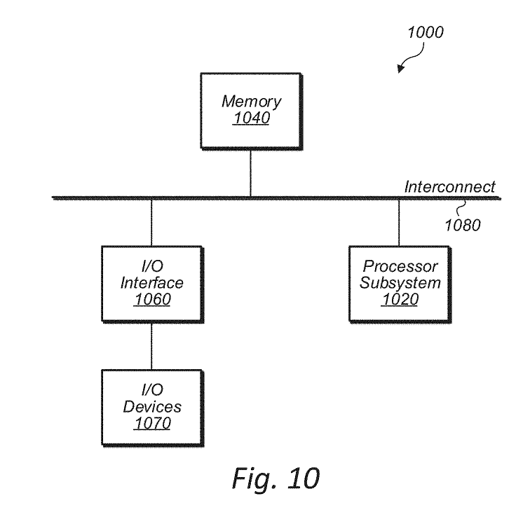

Turning now to FIG. 10, a block diagram of an example computer system 1000, which may implement one or more computer systems, such as system 100 of FIG. 1, is depicted. Computer system 1000 includes a processor subsystem 1020 that is coupled to a system memory 1040 and I/O interfaces(s) 1060 via an interconnect 1080 (e.g., a system bus). I/O interface(s) 1060 is coupled to one or more I/O devices 1070. Computer system 1000 may be any of various types of devices, including, but not limited to, a server system, personal computer system, desktop computer, laptop or notebook computer, tablet computer, handheld computer, workstation, network computer, a consumer device such as a mobile phone, music player, or personal data assistant (PDA). Although a single computer system 1000 is shown in FIG. 10 for convenience, computer system 1000 may also be implemented as two or more computer systems operating together.

Processor subsystem 1020 may include one or more processors or processing units. In various embodiments of computer system 1000, multiple instances of processor subsystem 1020 may be coupled to interconnect 1080. In various embodiments, processor subsystem 1020 (or each processor unit within 1020) may contain a cache or other form of on-board memory.

System memory 1040 is usable to store program instructions executable by processor subsystem 1020 to cause system 1000 perform various operations described herein. System memory 1040 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 1000 is not limited to primary storage such as system memory 1040. Rather, computer system 1000 may also include other forms of storage such as cache memory in processor subsystem 1020 and secondary storage on I/O Devices 1070 (e.g., a hard drive, storage array, etc.). In some embodiments, these other forms of storage may also store program instructions executable by processor subsystem 1020.

I/O interfaces 1060 may be any of various types of interfaces configured to couple to and communicate with other devices, according to various embodiments. In one embodiment, I/O interface 1060 is a bridge chip (e.g., Southbridge) from a front-side to one or more back-side buses. I/O interfaces 1060 may be coupled to one or more I/O devices 1070 via one or more corresponding buses or other interfaces. Examples of I/O devices 1070 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 1070 includes a network interface device (e.g., configured to communicate over WiFi, Bluetooth, Ethernet, etc.), and computer system 1000 is coupled to a network via the network interface device.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “mobile device configured to generate a hash value” is intended to cover, for example, a mobile device that performs this function during operation, even if the device in question is not currently being used (e.g., when its battery is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed computing device, for example, would not be considered to be “configured to” perform some specific function, although it may be “configurable to” perform that function. After appropriate programming, the computing device may then be configured to perform that function.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method comprising:
accessing, by a computer system, information indicative of computing activities of a set of users within a computing domain, wherein the information includes datasets associated with a plurality of software services available to the set of users;
analyzing, by the computer system, the datasets, wherein the analyzing comprises determining, using one or more machine learning algorithms, a plurality of objects, including objects representing ones of the set of users and a plurality of computing activities;
forming, by the computer system, a graph data structure, comprising the plurality of objects, that indicates relationships between the plurality of objects;
updating, by the computer system, the graph data structure in response to detecting additional computing activities of one or more of the set of users;
generating, by the computer system, a plot of a subset of the plurality of objects in the graph data structure in response to a request; and
causing, by the computer system, the plot to be displayed on a display.

2. The method of claim 1, further comprising:
responsive to detecting additional computing activities of the one or more of the set of users, the computer system storing additional data generated by the additional computing activities in respective datasets.

3. The method of claim 2, further comprising:
analyzing, by the computer system, the additional data, wherein the analyzing comprises determining, using one or more machine learning algorithms, one or more additional objects, including objects representing ones of the one or more of the set of users and the additional computing activities.

4. The method of claim 1, wherein accessing the datasets includes accessing separate data repositories available within the computing domain, wherein each separate data repository stores data that is generated via use of a respective one of the plurality of services.

5. The method of claim 1, wherein at least a portion of the datasets are datasets that are not stored in a relational database.

6. The method of claim 1, wherein the objects represent one or more of the following items within the datasets: people, projects, subjects.

7. The method of claim 1, wherein the graph data structure is a graph database.

8. The method of claim 1, wherein the plot includes a graphical representation of the subset of the plurality of objects as nodes and relationships between the subset of the plurality of objects as lines between the nodes.

9. The method of claim 1, wherein the plot is formed in response to receiving an indication in the request of at least one particular object of the plurality of objects, and wherein the generating comprises identifying the subset of the plurality of objects based on the at least one particular object.

10. The method of claim 1, wherein the request includes information that indicates a subject and wherein the subset of the plurality of nodes includes objects that represent people with experience in the subject.

11. The method of claim 1, wherein the plurality of services include one or more of the following services: an electronic mail service, a chat service, a software development platform, a webpage hosting service.

12. The method of claim 11, wherein the datasets are stored in respective ones of the following data repositories: an electronic mail repository that stores information generated via use of the electronic mail service, a chat history repository that stores information generated via use of the chat service, a software repository that stores information generated via use of the software development platform, a data repository that stores information generated via use of the webpage hosting service.

13. The method of claim 1, wherein at least a portion of the graph data structure indicates a level of expertise of a first user of the set of users with respect to one or more subjects.

14. The method of claim 13, wherein the level of expertise is based on computing activities of the first user.

15. A system comprising:
a plurality of data repositories respectively associated with a plurality of software services available over a network;
a processor communicatively coupled via the network to the plurality of data repositories; and
a memory coupled to the processor, wherein the memory has instructions stored thereon that are executable by the system to cause the system to perform operations comprising:
accessing information indicative of computing activities of a set of users in a computing domain, wherein the information includes datasets stored in the plurality of data repositories, wherein the datasets are associated with the plurality of software services available to the set of users;
analyzing the datasets, wherein the analyzing comprises determining, using one or more machine learning algorithms, a plurality of objects, including objects that represent ones of the set of users and a plurality of computing activities;
forming a graph data structure, comprising the plurality of objects, that indicates relationships between the plurality of objects;
repeatedly updating the graph data structure in response to detecting additional computing activities of one or more of the set of users;
generating a plot of a subset of the plurality of objects in the graph data structure in response to a request; and
causing the plot to be displayed on a display communicatively coupled to the system.

16. The system of claim 15, wherein the plurality of services include one or more of the following services: an electronic mail service, a chat service, a software development platform, a webpage hosting service.

17. The system of claim 16, wherein the plurality of data repositories include one or more of the following data repositories: an electronic mail repository that stores data generated via use of the electronic mail service, a chat history repository that stores data generated via use of the chat service, a software repository that stores data generated via use of the software development platform, a data repository that stores data generated via use of the webpage hosting service.

18. A non-transitory computer-readable medium having computer instructions stored thereon that are capable of being executed by a computer system to cause operations comprising:
accessing information indicative of computing activities of a set of users in a computing domain, wherein the information includes datasets associated with a plurality of services available to the set of users;
analyzing the datasets, wherein the analyzing comprises determining, using natural language processing, a plurality of objects, including objects that represent ones of the set of users and a plurality of computing activities;
forming a graph data structure, comprising the plurality of objects, that indicates relationships between the plurality of objects;
responsive to receiving an updated dataset that includes a change associated with a first object of the plurality of objects, updating the graph data structure; and
causing a first response to the change, wherein the first response includes generating an alert and sending the alert to a first plurality of users of the set of users.

19. The non-transitory computer-readable medium of claim 18, wherein the operations further comprise:
receiving an indication of the first object from the first plurality of users.

20. The non-transitory computer-readable medium of claim 19, wherein the causing the first response includes initiating an automated workflow.
